(19) United States
(12) Patent Application Publication
(10) Pub. No.: US 2026/0234439 A1
(43) Pub. Date: Aug. 13, 2026

(54) COMPOSITION OF HARD COATING, METHOD OF MANUFACTURING WINDOW, AND ELECTRONIC DEVICE

(71) Applicant: Samsung Display Co., LTD., Yongin-si, Gyeonggi-do (KR)

(72) Inventor: JONGHWAN CHO, Yongin-si, Gyeonggi-do (KR)

(73) Assignee: Samsung Display Co., LTD., Yongin-si, Gyeonggi-do (KR)

(21) Appl. No.: 19/228,034

(22) Filed: Jun. 4, 2025

(30) Foreign Application Priority Data
Sep. 24, 2024 (KR) 10-2024-0128833

(51) Int. Cl. C09D 183/04; C09D 7/20; C09D 7/40; C09D 7/63; G02B 1/14; G06F 1/16

(52) U.S. Cl. CPC C09D 183/04; C09D 7/20; C09D 7/63; C09D 7/67; G02B 1/14; G06F 1/1618; G06F 1/1641; G06F 1/1656

(57) ABSTRACT

A hard coating composition includes a solvent and a hard coating solid matter. The hard coating solid matter includes a silsesquioxane compound including a radical polymerizable functional group including a (meth)acrylate group and a cationic polymerizable functional group including an oxetane group, a radical polymerization initiator, and a cationic polymerization initiator.

### CROSS-REFERENCE TO RELATED APPLICATION(S)

This application claims priority to and the benefits of Korean Patent Application No. 10-2024-0128833 under 35 U.S.C. § 119, filed on Sep. 24, 2024, in the Korean Intellectual Property Office (KIPO), the entire contents of which are incorporated herein by reference.

### BACKGROUND

### 1. Technical Field

Embodiments relate to a hard coating composition. More specifically, embodiments relate to a hard coating composition for manufacturing a hard coating layer, a method of manufacturing a window including the hard coating layer, and an electronic device including the window.

### 2. Description of the Related Art

Various types of display devices are used to provide image information. The display device may include a display panel that displays an image and a window that protects the display panel. A user sees the image displayed on the display panel through the window.

The window may include various layers to improve durability, prevent fingerprints, or the like. For example, the window may include a base layer and a hard coating layer arranged on the base layer. The hard coating layer may function to improve durability such as hardness of the base layer.

### SUMMARY

Embodiments provide a hard coating composition for forming a hard coating layer.

Embodiments provide a method of manufacturing a window including the hard coating layer formed using the hard coating composition and having improved flexibility and durability.

However, embodiments are not limited to those set forth herein. The above and other embodiments will become more apparent to one of ordinary skill in the art to which the disclosure pertains by referencing the detailed description of the disclosure given below.

A hard coating composition according to an embodiment includes a solvent and a hard coating solid matter. The hard coating solid matter includes a silsesquioxane compound including a radical polymerizable functional group including a (meth)acrylate group and a cationic polymerizable functional group including an oxetane group, a radical polymerization initiator, and a cationic polymerization initiator.

In an embodiment, the radical polymerizable functional group may be EO (ethylene oxide)-modified isocyanurate diacrylate, and the cationic polymerizable functional group may be 2-ethylhexyloxetane.

In an embodiment, the silsesquioxane compound may include the radical polymerizable functional group and the cationic polymerizable functional group in a ratio of about 5:5 to about 6:4.

In an embodiment, the radical polymerization initiator may be diphenyl(2,4,6-trimethylbenzoyl) phosphine oxide.

In an embodiment, the cationic polymerization initiator may be triarylsulfonium hexafluoroantimonate salts.

In an embodiment, the hard coating composition may include about 80 wt % to about 91 wt % of the silsesquioxane compound, about 1 wt % to about 2 wt % of the radical polymerization initiator, and about 0.5 wt % to about 1 wt % of the cationic polymerization initiator with respect to 100% of the hard coating solid matter.

In an embodiment, the hard coating solid matter may further include silica nanoparticles.

In an embodiment, an average diameter of the silica nanoparticles may be in a range of about 20 nm to about 60 nm.

In an embodiment, the hard coating composition may include about 3 wt % to about 14 wt % of the silica nanoparticles with respect to 100 wt % of the hard coating solid matter.

In an embodiment, the silsesquioxane compound may have a random structure.

A method of manufacturing a window according to an embodiment includes applying a hard coating composition including a solvent and a hard coating solid matter on a base layer to form a preliminary hard coating layer, drying the preliminary hard coating layer to remove the solvent, and curing the dried preliminary hard coating layer to form a hard coating layer. The hard coating solid matter includes a silsesquioxane compound including a radical polymerizable functional group including a (meth)acrylate group and a cationic polymerizable functional group including an oxetane group, a radical polymerization initiator, and a cationic polymerization initiator.

In an embodiment, the radical polymerizable functional group may be EO (ethylene oxide)-modified isocyanurate diacrylate, and the cationic polymerizable functional group may be 2-ethylhexyloxetane.

In an embodiment, the silsesquioxane compound may include the radical polymerizable functional group and the cationic polymerizable functional group in a ratio of about 5:5 to about 6:4.

In an embodiment, the radical polymerization initiator may be diphenyl(2,4,6-trimethylbenzoyl) phosphine oxide, and the cationic polymerization initiator may be triarylsulfonium hexafluoroantimonate salts.

In an embodiment, the hard coating composition may include about 80 wt % to about 91 wt % of the silsesquioxane compound, about 1 wt % to about 2 wt % of the radical polymerization initiator, and about 0.5 wt % to about 1 wt % of the cationic polymerization initiator with respect to 100 wt % of the hard coating solid matter.

In an embodiment, the hard coating solid matter may further include silica nanoparticles.

In an embodiment, the curing of the dried preliminary hard coating layer to form the hard coating layer may include photocuring the dried preliminary hard coating layer.

In an embodiment, the curing of the dried preliminary hard coating layer to form the hard coating layer may further include thermally curing the dried preliminary hard coating layer.

In an embodiment, the silsesquioxane compound may have a random structure.

An electronic device according to an embodiment includes a window manufactured according to the method of manufacturing the window according to an embodiment and a power module that supplies power.

In a hard coating layer formed of a hard coating composition according to embodiments, the hard coating layer may have improved flexibility and hardness. Accordingly, a window including the hard coating layer may be suitably used in a foldable electronic device.

### BRIEF DESCRIPTION OF THE DRAWINGS

FIGS. 1, 2, and 3 are schematic perspective views illustrating an electronic device according to an embodiment.

FIG. 4 is a schematic cross-sectional view taken along line I-I′ of FIG. 1.

FIG. 5 is a schematic cross-sectional view illustrating a display panel included in the electronic device of FIG. 4.

FIG. 6 is a schematic cross-sectional view illustrating a window included in the electronic device of FIG. 4.

FIG. 7 is a schematic block diagram illustrating an electronic device according to an embodiment.

FIG. 8 is a schematic view illustrating electronic devices according to embodiments.

### DETAILED DESCRIPTION OF THE EMBODIMENTS

In the following description, for the purposes of explanation, numerous specific details are set forth in order to provide a thorough understanding of various embodiments or implementations of the invention. As used herein, “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the invention.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element or a layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the axis of the first direction DR1, the axis of the second direction DR2, and the axis of the third direction DR3 are not limited to three axes of a rectangular coordinate system, such as the X, Y, and Z-axes, and may be interpreted in a broader sense. For example, the axis of the first direction DR1, the axis of the second direction DR2, and the axis of the third direction DR3 may be perpendicular to one another, or may represent different directions that are not perpendicular to one another. For the purposes of this disclosure, “at least one of A and B” may be understood to mean A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art. For example, “about” may mean within one or more standard deviations, or within ±20%, ±10%, or ±5% of the stated value.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the invention. Further, the blocks, units, and/or modules of some embodiments may be physically combined into more complex blocks, units, and/or modules without departing from the scope of the invention.

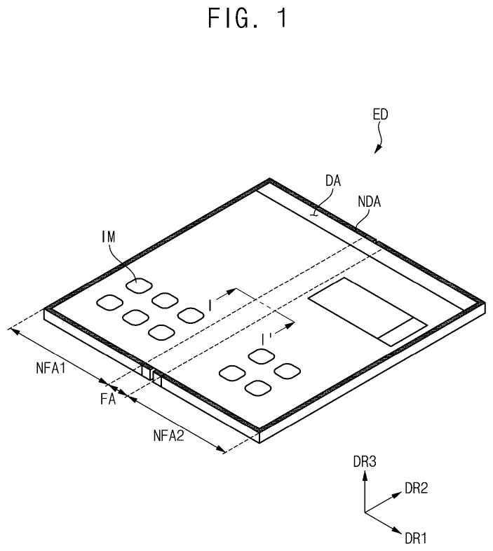

FIGS. 1, 2, and 3 are schematic perspective views illustrating an electronic device according to an embodiment.

Referring to FIGS. 1, 2, and 3, an electronic device ED may be a device that is activated by an electrical signal. For example, the electronic device ED may be a small electronic device such as a smartphone, a mobile phone, a smart watch, a game console, a camera, or the like, but embodiments are not limited thereto. FIGS. 1, 2, and 3 illustrate a foldable smartphone as an example of the small electronic device.

As illustrated in FIG. 1, the electronic device ED may include a display surface that displays an image IM. For example, the display surface may be substantially parallel to a plane defined by a first direction DR1 and a second direction DR2 intersecting the first direction DR1. For example, the first direction DR1 and the second direction DR2 may be perpendicular to each other. The electronic device ED may display the image IM in a third direction DR3 substantially parallel to a normal direction of the display surface. For example, the third direction DR3 may be perpendicular to each of the first direction DR1 and the second direction DR2. Hereinafter, the third direction DR3 may be referred to as a thickness direction.

The electronic device ED may include a display area DA and a non-display area NDA. The display area DA may be an area that generates light. The non-display area NDA may be positioned around the display area DA. For example, in a plan view, the non-display area NDA may surround at least a portion of the display area DA. In an embodiment, the non-display area NDA may be an area that does not display an image. However, embodiments are not limited thereto, and an image may be displayed in at least a portion of the non-display area NDA.

The electronic device ED may be a foldable electronic device that is folded or unfolded. The electronic device ED may include a folding area FA and a non-folding area NFA1 and NFA2. The folding area FA and the non-folding area NFA1 and NFA2 may be defined according to whether the electronic device ED is folded or not. The folding area FA may be an area in which the electronic device ED is folded, and the non-folding area NFA1 and NFA2 may be an area in which the electronic device ED is not folded.

In an embodiment, as illustrated in FIG. 1, the electronic device ED may include a first non-folding area NFA1 and a second non-folding area NFA2 spaced apart from each other. The folding area FA may be between the first non-folding area NFA1 and the second non-folding area NFA2. Although FIG. 1 illustrates that the electronic device ED includes one folding area and two non-folding areas, embodiments are not limited thereto, and the electronic device ED may include two or more folding areas and three or more non-folding areas.

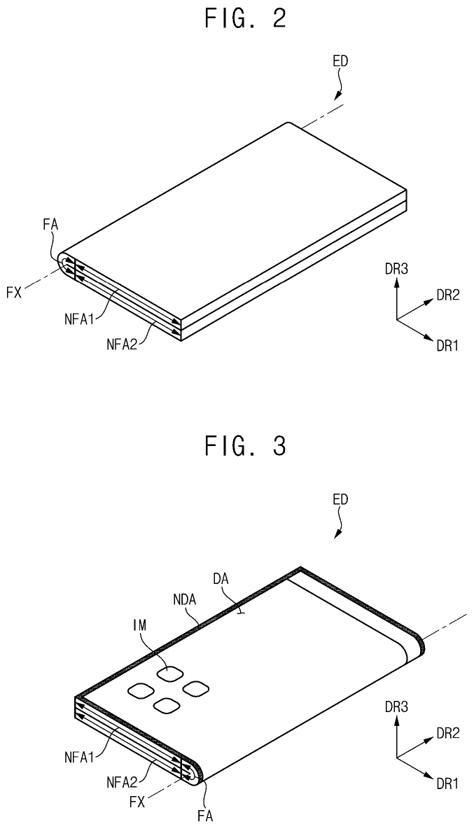

In an embodiment, the folding area FA may extend in the second direction DR2. The second non-folding area NFA2 may be spaced apart from the first non-folding area NFA1 in the first direction DR1. As illustrated in FIGS. 2 and 3, the electronic device ED may be folded with respect to a folding axis FX extending in the second direction DR2. The electronic device ED may be folded such that the first non-folding area NFA1 and the second non-folding area NFA2 face each other with respect to the folding area FA. The folding area FA may be folded to have a curvature.

Although FIGS. 2 and 3 illustrate that the folding area FA and the folding axis FX extend in a direction of a long side of the electronic device ED, embodiments are not limited thereto, and the folding area FA and the folding axis FX may extend in a direction of a short side of the electronic device ED.

In an embodiment, as illustrated in FIG. 2, the electronic device ED may be in-folded such that the display surface, which displays the image IM, may not be exposed to outside. In an embodiment, as illustrated in FIG. 3, the electronic device ED may be out-folded such that the display surface, which displays the image IM, may be exposed to the outside.

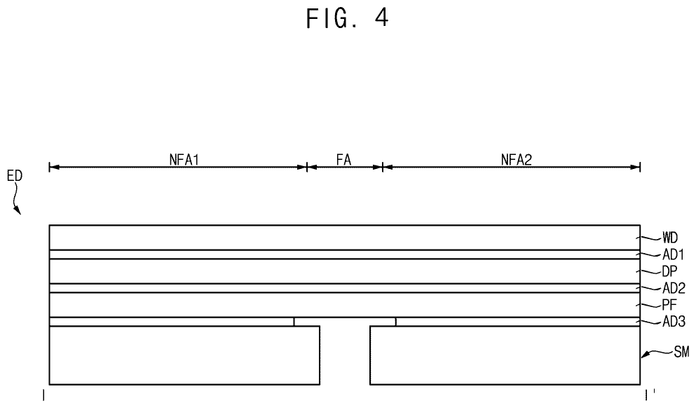

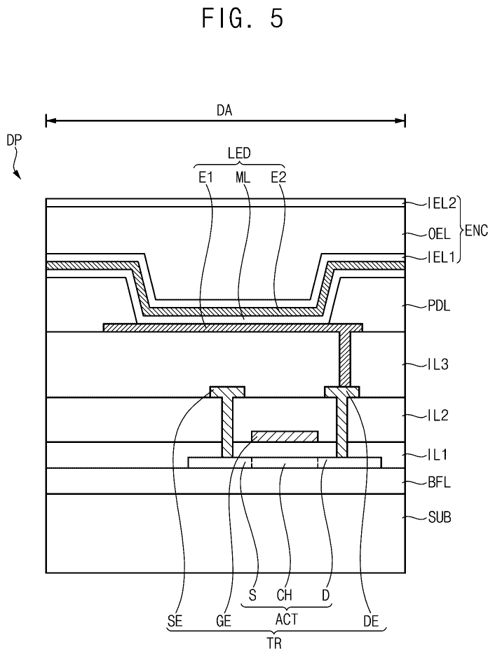

FIG. 4 is a schematic cross-sectional view taken along line I-I′ of FIG. 1. FIG. 5 is a schematic cross-sectional view illustrating a display panel included in the electronic device of FIG. 4.

Referring to FIGS. 1, 4, and 5, an electronic device ED may include a display panel DP, a protective layer PF, a support member SM, and a window WD.

As described above, the electronic device ED may include the first non-folding area NFA1, the second non-folding area NFA2, and the folding area FA. Each of the display panel DP, the protective layer PF, the support member SM, and the window WD may include the first non-folding area NFA1, the second non-folding area NFA2, and the folding area FA.

The protective layer PF and the support member SM may be arranged below the display panel DP (e.g., in a direction opposite to the third direction DR3), and the window WD may be arranged on the display panel DP (e.g., in the third direction DR3).

The display panel DP may include pixels that generate an image. The pixels may be arranged in the display area DA. Light emitted from each of the pixels may be combined to generate the image. Each of the pixels may include a pixel circuit including at least one transistor TR and a light emitting element LED. The pixel circuit may further include at least one capacitor.

The display panel DP may include a substrate SUB, a buffer layer BFL, the pixels, insulating layers IL1, IL2, and IL3, a pixel defining layer PDL, and an encapsulation layer ENC.

The substrate SUB may form a base of the display panel DP. The substrate SUB may be an insulating substrate formed of a transparent material or an opaque material. The substrate SUB may include plastic and have flexibility. The substrate SUB may have a single-layer structure or a multi-layer structure.

The buffer layer BFL may be arranged on the substrate SUB. The buffer layer BFL may prevent an impurity such as oxygen, moisture, or the like from diffusing to an upper portion of the substrate SUB through the substrate SUB. For example, the buffer layer BFL may include an inorganic insulating material such as a silicon compound, a metal oxide, or the like. For example, the buffer layer BFL may include silicon oxide (SiOx), silicon nitride (SiNx), silicon oxynitride (SiOxNy), silicon oxycarbide (SiOxCy), silicon carbonitride (SiCxNy), aluminum oxide (AlOx), aluminum nitride (AlNx), tantalum oxide (TaOx), hafnium oxide (HfOx), zirconium oxide (ZrOx), titanium oxide (TiOx), or the like. These may be used alone or in combination with each other.

The transistor TR may be arranged on the buffer layer BFL. The transistor TR may include an active layer ACT, a gate electrode GE, a first contact electrode SE, and a second contact electrode DE.

The active layer ACT may be arranged on the buffer layer BFL. The active layer ACT may include an oxide semiconductor, a silicon semiconductor, or the like. For example, the oxide semiconductor may include at least one selected from oxides of indium (In), gallium (Ga), tin (Sn), zirconium (Zr), vanadium (V), hafnium (Hf), cadmium (Cd), germanium (Ge), chromium (Cr), titanium (Ti), and zinc (Zn). The silicon semiconductor may include amorphous silicon, polycrystalline silicon, or the like. The active layer ACT may include a first contact area S, a second contact area D, and a channel area CH between the first contact area S and the second contact area D. The first contact area S and the second contact area D may have higher conductivity than the channel area CH.

The first insulating layer IL1 may be arranged on the active layer ACT. The first insulating layer IL1 may cover the active layer ACT on the buffer layer BFL. For example, the first insulating layer IL1 may include an inorganic insulating material.

The gate electrode GE may be arranged on the first insulating layer IL1. The gate electrode GE may overlap the channel area CH of the active layer ACT in a plan view. The gate electrode GE may include a conductive material such as a metal, an alloy, a conductive metal nitride, a conductive metal oxide, a transparent conductive material, or the like. For example, the gate electrode GE may include gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Ir), alloys containing aluminum, alloys containing silver, alloys containing copper, alloys containing molybdenum, aluminum nitride (AlNₓ), tungsten nitride (WNₓ), titanium nitride (TiNₓ), chromium nitride (CrNₓ), tantalum nitride (TaNₓ), strontium ruthenium oxide (SrRuOₓ), zinc oxide (ZnOₓ), indium tin oxide (ITO), tin oxide (SnOₓ), indium oxide (InOₓ), gallium oxide (GaOₓ), indium zinc oxide (IZO), or the like. These may be used alone or in combination with each other.

The second insulating layer IL2 may be arranged on the gate electrode GE. The second insulating layer IL2 may cover the gate electrode GE on the first insulating layer IL1. The second insulating layer IL2 may include an inorganic insulating material.

The first contact electrode SE and the second contact electrode DE may be arranged on the second insulating layer IL2. The first contact electrode SE and the second contact electrode DE may be connected to the first contact area S and the second contact area D of the active layer ACT, respectively. Each of the first contact electrode SE and the second contact electrode DE may include a conductive material.

The third insulating layer IL3 may be arranged on the first contact electrode SE and the second contact electrode DE. For example, the third insulating layer IL3 may include an organic insulating material. For example, the third insulating layer IL3 may include photoresist, polyacryl-based resin, polyimide-based resin, polyamide-based resin, siloxane-based resin, acryl-based resin, epoxy-based resin, or the like. These may be used alone or in combination with each other.

The light emitting element LED may be arranged on the third insulating layer IL3. The light emitting element LED may include a first electrode E1, an intermediate layer ML, and a second electrode E2.

The first electrode E1 may be arranged on the third insulating layer IL3. The first electrode E1 may include a conductive material. The first electrode E1 may be electrically connected to the transistor TR. For example, the first electrode E1 may be connected to the second contact electrode DE (or, the first contact electrode SE) through a contact hole formed in the third insulating layer IL3. For example, the first electrode E1 may serve (or function) as an anode of the light emitting element LED.

The pixel defining layer PDL may be arranged on the first electrode E1. The pixel defining layer PDL may cover a peripheral portion of the first electrode E1, and may define a pixel opening exposing a central portion of the first electrode E1. A light emitting area may be defined by the pixel opening. For example, the pixel defining layer PDL may include an organic insulating material. In an embodiment, the pixel defining layer PDL may further include an inorganic material or an organic material containing a light blocking material having a black color.

The intermediate layer ML may be arranged on the first electrode E1 and the pixel defining layer PDL. A portion of the intermediate layer ML may be arranged in the pixel opening of the pixel defining layer PDL. In an embodiment, the intermediate layer ML may include a first functional layer including an organic material, a light emitting layer arranged on the first functional layer and including a light emitting material, and a second functional layer arranged on the light emitting layer and including an organic material. For example, the first functional layer may include a hole injection layer, a hole transport layer, or the like, and the second functional layer may include an electron transport layer, an electron injection layer, or the like. For example, the light emitting layer may include at least one of an organic light emitting material and quantum dot.

The second electrode E2 may be arranged on the intermediate layer ML. For example, the second electrode E2 may include a conductive material. For example, the second electrode E2 may serve (or function) as a cathode of the light emitting element LED.

The encapsulation layer ENC may be arranged on the second electrode E2. The encapsulation layer ENC may include at least one inorganic encapsulation layer and at least one organic encapsulation layer. In an embodiment, the encapsulation layer ENC may include a first inorganic encapsulation layer IEL1 arranged on the second electrode E2, an organic encapsulation layer OEL arranged on the first inorganic encapsulation layer IEL1, and a second inorganic encapsulation layer IEL2 arranged on the organic encapsulation layer OEL. For example, various functional layers, such as a touch sensing layer, a color filter layer, a light collecting layer, or the like may be additionally arranged on the encapsulation layer ENC.

The protective layer PF may be arranged below the display panel DP. The protective layer PF may protect a lower surface of the display panel DP. In an embodiment, the protective layer PF may include plastic, and may be flexible. For example, the protective layer PF may include (or may be) polyethyleneterephthalate (PET) film or polyimide (PI) film, but embodiments are not limited thereto.

The support member SM may be arranged below the protective layer PF. The support member SM may support the display panel DP, and may prevent deformation of the display panel DP from external impact, or the like. In an embodiment, the support member SM may include various functional layers, such as a cushion layer, a shielding layer, a heat dissipation layer, a support plate, or the like.

The window WD may be arranged on the display panel DP. The window WD may cover an entire upper surface (e.g., the display surface) of the display panel DP. The window WD may protect the display panel DP from external impact. The window WD may be flexible so as to be folded according to the folding of the electronic device ED. The window WD will be described in detail later.

As illustrated in FIG. 4, adhesive layers AD1, AD2, and AD3 may be arranged between respective components of the electronic device ED. For example, a first adhesive layer AD1 may be arranged between the display panel DP and the window WD to adhere the display panel DP and the window WD, a second adhesive layer AD2 may be arranged between the display panel DP and the protective layer PF to adhere the display panel DP and the protective layer PF, and a third adhesive layer AD3 may be arranged between the protective layer PF and the support member SM to adhere the protective layer PF and the support member SM. For example, each of the adhesive layers AD1, AD2, and AD3 may include (or may be) a pressure sensitive adhesive film (PSA), an optically clear adhesive film (OCA), an optically clear resin (OCR), or the like.

For example, the electronic device ED may further include a housing coupled with the window WD. The housing may be coupled with the window WD to provide an internal space. The display panel DP, the protective layer PF, and the support member SM may be accommodated in the internal space provided between the housing and the window WD. The housing may stably protect the components accommodated in the internal space from external impact.

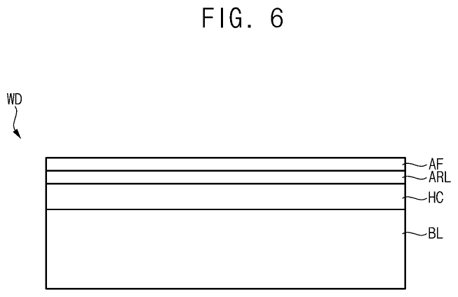

FIG. 6 is a schematic cross-sectional view illustrating a window included in the electronic device of FIG. 4.

Referring to FIG. 6, the window WD may include a base layer BL, a hard coating layer HC, an anti-reflection layer ARL, and an anti-fingerprint layer AF.

In an embodiment, the base layer BL may include a plastic film, and may have flexibility. For example, the base layer BL may be a polyethyleneterephthalate (PET) film or a polyimide (PI) film, but embodiments are not limited thereto.

The hard coating layer HC may be arranged on the base layer BL. In an embodiment, the hard coating layer HC may be arranged (e.g., directly arranged) on an upper surface of the base layer BL. The hard coating layer HC may have a relatively greater hardness. For example, the hardness of the hard coating layer HC may be greater than a hardness of the base layer BL. The hard coating layer HC may increase a durability of the window WD so as to effectively protect the display panel DP from an external impact. For example, the hard coating layer HC may have relatively greater flexibility. The hard coating layer HC may have flexibility so as to be foldable.

The hard coating layer HC may be formed of a polymer compound, a polymerization initiator, and silica nanoparticles. In an embodiment, a thickness of the hard coating layer HC may be about 3 micrometers (μm) to about 5 μm, but embodiments are not limited thereto. The hard coating layer HC will be described later together with a method of manufacturing the window WD.

The anti-reflection layer ARL may be arranged on the hard coating layer HC. The anti-reflection layer ARL may reduce reflectance of external light of the window WD. In an embodiment, the anti-reflection layer ARL may include high refractive index layers and low refractive index layers. A refractive index of each of the high refractive index layers may be greater than a refractive index of each of the low refractive index layers.

The high refractive index layers and the low refractive index layers may be alternately stacked in the thickness direction (e.g., in the third direction DR3 of FIG. 1). In an embodiment, the anti-reflection layer ARL may include a total of three or more layers of the high refractive index layers and the low refractive index layers stacked alternately in the thickness direction. For example, the anti-reflection layer ARL may include a total of five layers of the high refractive index layers and the low refractive index layers stacked alternately in the thickness direction, but embodiments are not limited thereto.

In an embodiment, each of the high refractive index layers may include titanium-niobium oxide (TiₓNb_{y}O_{z}). For example, each of the high refractive index layers may include Ti₁₄Nb₃O₃₅, but embodiments are not limited thereto.

In an embodiment, each of the low refractive index layers may include silicon oxide (SiₓO_{y}). For example, each of the low refractive index layers may include SiO₂, but embodiments are not limited thereto.

The anti-fingerprint layer AF may be arranged on the anti-reflection layer ARL. The anti-fingerprint layer AF may prevent a fingerprint from being formed on an upper surface of the electronic device ED. For example, the anti-fingerprint layer AF may include a metal oxide, a silicon-based compound, a fluorine-based compound, or the like. In another example, at least one of the anti-reflection layer ARL and the anti-fingerprint layer AF may be omitted.

Hereinafter, a method of manufacturing the window WD according to an embodiment will be described in detail.

First, a hard coating composition may be prepared. The hard coating composition may include a solvent, a polymer compound, a polymerization initiator, and silica nanoparticles. Hereinafter, a phrase “hard coating solid matter” may refer to all components other than the solvent in the hard coating composition, for example, the polymer compound, the polymerization initiator, and the silica nanoparticles.

In an embodiment, the solvent may include a ketone-based solvent or an alcohol-based solvent. For example, the solvent may include at least one of 2-butanone (MEK) and 1-methoxy-2-methyl-2-propanol (PGM). For example, a mixture of MEK and PGM may be used as the solvent, or MEK or PGM may be used alone as the solvent. A weight ratio of the solvent may be about 70 wt % to about 90 wt % with respect to 100 wt % of the hard coating composition. However, this is an example and embodiments are not limited thereto.

The polymer compound may be a polymerizable compound including a polymerizable functional group. In an embodiment, the polymer compound may be a silsesquioxane compound including a polymerizable functional group. For example, the polymer compound may be a silsesquioxane compound represented by Formula 1.

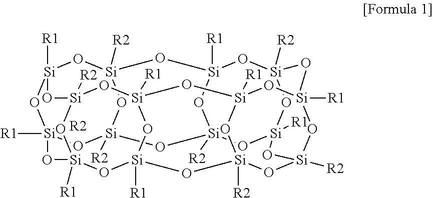

In Formula 1, each of R1 and R2 may be a polymerizable functional group. R1 and R2 may be different polymerizable functional groups. In an embodiment, R1 may be a radical polymerizable functional group, and R2 may be a cationic polymerizable functional group. In an embodiment, R1 may include a (meth)acrylate group, and R2 may include an oxetane group.

In an embodiment, the radical polymerizable functional group (i.e., R1) may be EO (ethylene oxide)-modified isocyanurate diacrylate, and the cationic polymerizable functional group (i.e., R2) may be 2-ethylhexyloxetane.

The radical polymerizable functional group and the cationic polymerizable functional group may be functional groups for different properties of the hard coating layer HC. In an embodiment, the radical polymerizable functional group may be a functional group that improves a hardness of the hard coating layer HC, and the cationic polymerizable functional group may be a functional group that improves a flexibility of the hard coating layer HC. In an embodiment, the silsesquioxane compound may include the radical polymerizable functional group and the cationic polymerizable functional group in a ratio of about 5:5 to about 6:4.

However, embodiments are not limited to the polymer compound including two functional groups (i.e., R1 and R2), and for example, the polymer compound may further include a functional group that does not react with each of the two functional groups. In an embodiment, the functional group may be a functional group including an oxetane group in a main chain and a (meth)acrylate group in a side chain. The oxetane group may further improve the flexibility of the hard coating layer HC, and the acrylate group may further improve the hardness of the hard coating layer HC. For example, the functional group may be a functional group represented by Formula 2, but this is an example and embodiments are not limited thereto.

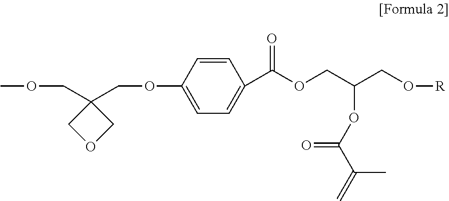

In an embodiment, as represented in Formula 1, the silsesquioxane compound may have a random structure. In case that the silsesquioxane compound has the random structure, the hardness and the flexibility of the hard coating layer HC may be relatively improved compared to that the silsesquioxane compound has a different structure.

However, embodiments are not limited thereto, and the silsesquioxane compound may have various structures such as a ladder structure, a complete or incomplete cage structure, or the like. In case that the silsesquioxane compound has a structure other than the random structure, the silsesquioxane compound may include the radical polymerizable functional group and the cationic polymerizable functional group in a ratio of about 5:5 to about 6:4.

The polymerization initiator may initiate a polymerization reaction of the polymer compound. In an embodiment, the polymerization initiator may include a radical polymerization initiator and a cationic polymerization initiator. The radical polymerization initiator may generate radicals by light, and thus, the hard coating composition may be photo-cured. The cationic polymerization initiator may generate cations by light and/or heat, and thus, the hard coating composition may be photo-cured and/or thermally cured.

In an embodiment, a polymerization reaction of the radical polymerizable functional group of the silsesquioxane compound may be initiated by the radical polymerization initiator, and thus, the hard coating layer HC with improved heat resistance and hardness may be formed. In an embodiment, the radical polymerization initiator may be diphenyl(2,4,6-trimethylbenzoyl) phosphine oxide, but embodiments are not limited thereto.

In an embodiment, a polymerization reaction of the cationic polymerizable functional group of the silsesquioxane compound may be initiated by the cationic polymerization initiator, and thus, the hard coating layer HC with improved flexibility may be formed. In an embodiment, the cationic polymerization initiator may be triarylsulfonium hexafluoroantimonate salts, but embodiments are not limited thereto.

The silica nanoparticles may be dispersed in the solvent. The silica nanoparticles may partially bind to the silsesquioxane compound to enhance bonding strength, and may improve wear resistance of the hard coating layer HC. In an embodiment, an average diameter of the silica nanoparticles may be about 20 nanometers (nm) to about 60 nm. However, embodiments are not limited thereto, and for example, the average diameter of the silica nanoparticles may be less than about 20 nm or greater than about 60 nm. For example, the average diameter and/or content of the silica nanoparticles may be variously modified so as to enhance the wear resistance of the hard coating layer HC.

In an embodiment, the hard coating composition may include about 91 wt % or less of the silsesquioxane compound, about 2 wt % or less of the radical polymerization initiator, about 1 wt % or less of the cationic polymerization initiator, and about 3 wt % or more of the silica nanoparticles with respect to 100 wt % of the hard coating solid matter. For example, the hard coating composition may include about 80 wt % to about 91 wt % of the silsesquioxane compound, about 1 wt % to about 2 wt % of the radical polymerization initiator, about 0.5 wt % to about 1 wt % of the cationic polymerization initiator, and about 3 wt % to about 14 wt % of the silica nanoparticles with respect to 100 wt % of the hard coating solid matter. In an embodiment, the hard coating composition may further include an additive that controls the hardness and/or the flexibility of the hard coating layer HC.

The prepared hard coating composition may be applied on the base layer BL to form a preliminary hard coating layer. The hard coating composition may be applied on one surface of the base layer BL. In an embodiment, the hard coating composition may be applied by wet coating, but embodiments are not limited thereto.

The preliminary hard coating layer formed on the base layer BL may be dried. In the step of drying the preliminary hard coating layer, the solvent included in the hard coating composition may be removed.

In an embodiment, the dried preliminary hard coating layer may be photo-cured. The preliminary hard coating layer may include the hard coating solid matter including the silsesquioxane compound, the radical polymerization initiator, the cationic polymerization initiator, and the silica nanoparticles. In case that light is irradiated, a polymerization reaction of the silsesquioxane compound may be initiated by the radical polymerization initiator and the cationic polymerization initiator. For example, in case that the light is irradiated, a photo-polymerization reaction of the radical polymerizable functional group of the silsesquioxane compound may be initiated by the radical polymerization initiator, and a photo-polymerization reaction of the cationic polymerizable functional group of the silsesquioxane compound may be initiated by the cationic polymerization initiator. For example, the radical photo-polymerization reaction and the cationic photo-polymerization reaction of the silsesquioxane compound may be performed simultaneously.

Accordingly, the preliminary hard coating layer may be cured to form the hard coating layer HC. The hard coating layer HC may include a cross-linked structure formed by curing (i.e., photocuring) the silsesquioxane compound. Since the radical polymerization reaction and the cationic polymerization reaction are performed simultaneously, the hard coating layer HC having a relatively small shrinkage ratio, relatively high adhesion, and relatively low oxygen interference during the forming process may be formed. In an embodiment, the hard coating layer HC may be formed to a thickness of about 3 μm to about 5 μm.

In an embodiment, the dried preliminary hard coating layer may be photo-cured, and then thermally cured. The preliminary hard coating layer may include the hard coating solid matter including the silsesquioxane compound, the radical polymerization initiator, the cationic polymerization initiator, and the silica nanoparticles.

First, in case that light is irradiated, a polymerization reaction of the silsesquioxane compound may be initiated by the radical polymerization initiator and the cationic polymerization initiator. In case that the light is irradiated, a photo-polymerization reaction of the radical polymerizable functional group of the silsesquioxane compound may be initiated by the radical polymerization initiator, and a photo-polymerization reaction of the cationic polymerizable functional group of the silsesquioxane compound may be initiated by the cationic polymerization initiator. For example, the radical photo-polymerization reaction and the cationic photo-polymerization reaction of the silsesquioxane compound may be performed simultaneously.

Thereafter, in case that heat is provided, a polymerization reaction of the silsesquioxane compound may be further initiated by the cationic polymerization initiator. In case that the heat is provided, a thermal polymerization reaction of the cationic polymerizable functional group of the silsesquioxane compound may be further initiated by the cationic polymerization initiator. For example, the cationic thermal polymerization reaction of the silsesquioxane compound may be further performed. Since the radical polymerizable functional group of the silsesquioxane compound (e.g., the photo-polymerized radical polymerizable functional group) has heat resistance, the hardness property may not be changed by the heat provided.

Accordingly, the preliminary hard coating layer may be cured to form the hard coating layer HC. The hard coating layer HC may include a cross-linked structure formed by curing (i.e., photocuring and thermal curing) the silsesquioxane compound. Since the radical polymerization reaction and the cationic polymerization reaction are performed simultaneously, the hard coating layer HC having a relatively small shrinkage ratio, relatively high adhesion, and relatively low oxygen interference during the forming process may be formed. For example, since the photocuring and the thermal curing are performed sequentially, the hard coating layer HC having relatively improved hardness and flexibility may be formed. In an embodiment, the hard coating layer HC may be formed to a thickness of about 3 μm to about 5 μm.

The anti-reflection layer ARL may be formed on the hard coating layer HC. In an embodiment, the high refractive index layers and the low refractive index layers may be alternately stacked on the hard coating layer HC. For example, the high refractive index layers and the low refractive index layers may be formed by vacuum deposition. The anti-fingerprint layer AF may be coated on the anti-reflection layer ARL, and thus, the window WD may be formed.

In an embodiment, the hardness of the window WD may be about 0.5 GPa or more, e.g., about 0.65 GPa or more. For example, an elastic modulus of the window WD may be about 6.5 GPa or more, e.g., about 7.29 GPa or more. In an embodiment, a reflectance of the window WD may be about 0.5% to about 1.5%, e.g., about 1.0% or less. In an embodiment, a crack strain of the window WD may be about 10% or more. In an embodiment, the window WD may exhibit good surface properties even after about 5,000 and about 3,000 reciprocating rubbing cycles in wear resistance and chemical resistance tests with a load of about 1.0 kg, respectively. For example, a water contact angle of the window WD before the wear and chemical resistance tests may be about 100° or more, and the water contact angle of the window WD after the wear and chemical resistance tests may be about 95° or more.

According to embodiments, the hard coating layer HC of the window WD may have not only improved hardness and wear resistance, but also improved flexibility. Accordingly, the hardness and the flexibility of the window WD may be improved, so that the window WD may be suitably used in an electronic device (e.g., a foldable electronic device).

Hereinafter, effects of embodiments will be described through specific experimental examples.

### [Evaluation of Window]

A window according to a comparative example 1, a window according to a comparative example 2, and a window according to an embodiment were each manufactured, and crack strain, reflectance, surface hardness, wear resistance, and chemical resistance of each of the windows were evaluated.

### [Manufacturing of Window]

The window according to the comparative example 1 and the window according to the comparative example 2 were each manufactured by forming a hard coating layer having a thickness of 5 μm on a polyethyleneterephthalate (PET) film having a thickness of 65 μm and forming an anti-reflection layer on the hard coating layer (e.g., forming the anti-reflection layer by alternately vacuum depositing a total of 5 layers of Ti₁₄Nb₃O₃₅ films and Si₉Al₂O₁₀ films on the hard coating layer).

The window according to the embodiment was manufactured by forming a hard coating layer having a thickness of about 5 μm on a polyethyleneterephthalate (PET) film having a thickness of about 65 μm and forming an anti-reflection layer on the hard coating layer (e.g., forming the anti-reflection layer by alternately vacuum depositing a total of 5 layers of Ti₁₄Nb₃O₃₅ films and SiO₂ films on the hard coating layer). The windows of the comparative example 1, the comparative example 2, and the embodiment were manufactured under the same conditions, except for hard coating compositions used in manufacturing the hard coating layer and some compositions used in the anti-reflection layer.

The hard coating layer of the comparative example 1 was formed of a hard coating composition including 95 wt % of a silsesquioxane compound as a polymerizable compound having a cage structure with 2-ethylhexyloxetane as a cationic photo-polymerizable mono-functional group, about 3 wt % of 2-(1,3-benzodioxol-5-yl)-4,6-bis(trichloromethyl)-1,3,5-triazine as a cationic photo-polymerization initiator, and 2 wt % of an additive, with respect to 100 wt % of a hard coating solid matter.

The hard coating layer of the comparative example 2 was formed of a hard coating composition including 93 wt % of a silsesquioxane compound as a polymerizable compound having a cage structure with pentaerythritol triacrylate (PETA) and trimethylolpropane trimethacrylate (TMPTMA) as radical photo-polymerizable functional groups, 2 wt % of diphenyl(2,4,6-trimethylbenzoyl) phosphine oxide as a radical photo-polymerization initiator, 3 wt % of silica nanoparticles, and 2 wt % of an additive, with respect to 100 wt % of a hard coating solid matter.

The hard coating layer of the embodiment was formed of a hard coating composition including about 91 wt % of a silsesquioxane compound as a polymerizable compound having a random structure with EO-modified isocyanurate diacrylate as a radical photo-polymerizable functional group and 2-Ethylhexyloxetane as a cationic photo/thermal-polymerizable functional group, about 2 wt % of diphenyl(2,4,6-trimethylbenzoyl) phosphine oxide as a radical photo-polymerization initiator, about 1 wt % of triarylsulfonium hexafluoroantimonate salts (mixed) as a cationic photo/thermal-polymerization initiator, about 3 wt % of silica nanoparticles, and about 3 wt % of an additive, with respect to 100 wt % of a hard coating solid matter.

Evaluation methods for crack strain, reflectance, surface hardness, wear resistance, and chemical resistance are as follows.

### [Crack Strain]

Crack strain indicates a degree of increase in a size of a sample after tension with respect to an initial sample in case that the sample is tensioned. Samples for measuring crack strain were prepared by cutting the windows according to the comparative example 1, the comparative example 2, and the embodiment into a size of about 10 millimeters (mm)×about 60 mm, respectively. Each of the prepared samples was tensioned using a tensile testing machine from Instron (e.g., universal testing machine) at a tensile speed of about 50 mm/min. After tensioning, occurrence of cracks was checked and a degree of increase in a size of the samples was measured for evaluation.

### [Reflectance]

Reflectance of each of the windows according to the comparative example 1, the comparative example 2, and the embodiment was measured at 550 nm using CM3700A reflection mode from Konica Minolta.

### [Surface Hardness]

Surface hardness was measured using a nano-indenter (TI-950 Berkovich diamond Tip from Bruker Corporation), and surfaces of each of the windows according to the comparative example 1, the comparative example 2, and the embodiment was indented with an indentation depth of 200 nm.

### [Wear Resistance]

Wear resistance was evaluated by measuring a water contact angle after a wear test with an eraser. Samples for measuring wear resistance were prepared by cutting the windows according to the comparative example 1, the comparative example 2, and the embodiment into a size of 70 mm×80 mm, respectively. Each of the prepared samples was fixed to a jig of a wear resistance measuring device (scratch tester from Daesung Precision Corporation), and an eraser (Rubber stick of Munbang Sau Corporation) having a diameter of 5 mm was applied and fixed on a tip. The eraser was reciprocally rubbed against each of the surfaces of the windows by setting a moving distance to 15 mm, speed to 50 rpm, and a load to 1.0 kg. Then, each of the surfaces was observed with a naked eye, or the water contact angle of each of the worn surface was measured using a contact angle measuring device (drop shape analysis system from Kruss Corporation).

### [Chemical Resistance]

Chemical resistance was evaluated by applying alcohol to surfaces of each of the windows according to the comparative example 1, the comparative example 2, and the embodiment, and an eraser was reciprocally rubbed against the surfaces of each of the windows under the same conditions as those for evaluating the wear resistance. Then, each of the surface was observed with the naked eye, or the water contact angle of each of the worn surface was measured.

Table 1 shows the results of evaluating crack strain, reflectance, surface hardness, wear resistance, and chemical resistance for the windows according to the comparative example 1, the comparative example 2, and the embodiment.

TABLE 1

| | | Comparative | Comparative | |
|---|---|---|---|---|
| | | example 1 | example 2 | Embodiment |
| crack strain (%) | | 16.0 | 7.5 | 10.5 |
| reflectance (%) | | 0.61~0.7 | 0.56~0.69 | 0.62~0.71 |
| surface hardness (GPa) | | 0.52 | 0.7 | 0.5 |
| wear | number of times rubbed | 3000 | 10000 | 10000 |
| resistance | water contact angle (°) | 97.2 | 106.1 | 99.7 |
| chemical | number of times rubbed | 2000 | 3000 | 3000 |
| resistance | water contact angle (°) | 96.8 | 101.7 | 102.3 |

Referring to Table 1, it may be noted that the window of the comparative example 1 has excellent flexibility since the silsesquioxane compound has the cationic polymerizable mono-functional group, so that the crack strain is measured high, but the surface hardness, wear resistance, and chemical resistance are measured low. The window of the comparative example 2 has excellent hardness since the silsesquioxane compound has only the radical polymerizable functional group, so that the surface hardness is measured high, but the crack strain is measured low.

It may be confirmed that the window of the embodiment has excellent crack strain, surface hardness, wear resistance, and chemical resistance compared to the window of the comparative example 1 or the window of the comparative example 2.

For example, the window of the embodiment was measured to have a crack strain of 10.5%, which exceeded target value of 10%, a reflectivity of 0.65% to 0.71%, which satisfied target value of 1.0%, and a surface hardness of 0.5 GPa, which was excellent. For example, an elastic modulus of the window of the embodiment was measured to be 6.5 GPa. For example, the window of the embodiment exhibited good surface properties even after 10,000 and 3,000 reciprocating rubbing cycles in the wear resistance and chemical resistance tests, exceeding target values of 5,000 and 3,000 reciprocating rubbing cycles, and the water contact angle of the window of the embodiment was maintained at target value of 95° or higher even after the wear resistance and chemical resistance tests, indicating that the window of the embodiment has excellent wear resistance and chemical resistance.

The window WD according to embodiments may be applied to various electronic devices. An electronic device according to an embodiment may include the window WD described above, and may further include a module or device having additional functions in addition to the window WD.

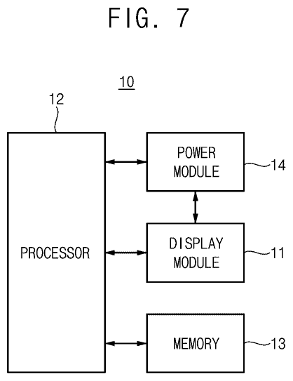

FIG. 7 is a schematic block diagram illustrating an electronic device according to an embodiment.

Referring to FIG. 7, an electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data information necessary for an operation of the processor 12 or the display module 11. In case that the processor 12 executes an application stored in the memory 13, an image data signal and/or an input control signal may be transmitted to the display module 11, and the display module 11 may process the received signal and output image information through a display screen.

The power module 14 may include a power supply module such as a power adapter, a battery device, or the like and a power conversion module that converts power supplied by the power supply module to generate power necessary for an operation of the electronic device 10.

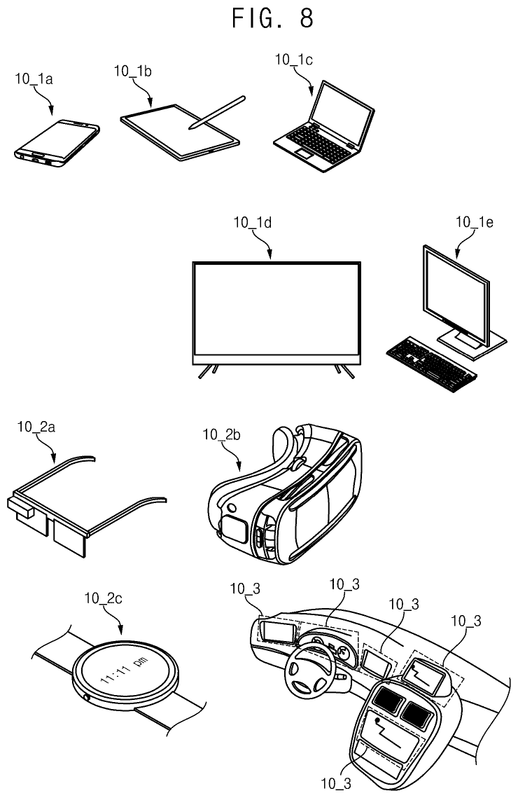

FIG. 8 is a schematic view illustrating electronic devices according to embodiments.

Referring to FIG. 8, various electronic devices to which the window according to an embodiment is applied may include not only an image display electronic device, but also a wearable electronic device including a display module, a vehicle electronic device 10_3 including a display module, or the like. The image display electronic device may be a smartphone 10_1a, a tablet PC 10_1b, a laptop 10_1c, a TV 10_1d, a desk monitor 10_1e, or the like. The wearable electronic device may be smart glasses 10_2a, a head mounted display 10_2b, a smart watch 10_2c, or the like. The vehicle electronic device 10_3 may be a center information display (CID) arranged on a dashboard and center fascia of a vehicle, a room mirror display, or the like.

The disclosure may be applied to various display devices and electronic devices. For example, embodiments are applicable to various display devices such as display devices for vehicles, ships and aircraft, portable communication devices, display devices for exhibition or information transmission, medical display devices, and the like.

In concluding the detailed description, those skilled in the art will appreciate that many variations and modifications may be made to the embodiments without substantially departing from the principles and spirit and scope of the disclosure. Therefore, the disclosed embodiments are used in a generic and descriptive sense only and not for purposes of limitation.

What is claimed is:

1. A hard coating composition comprising:
a solvent; and
a hard coating solid matter including:
a silsesquioxane compound including a radical polymerizable functional group including a (meth)acrylate group and a cationic polymerizable functional group including an oxetane group;
a radical polymerization initiator; and
a cationic polymerization initiator.

2. The hard coating composition of claim 1, wherein
the radical polymerizable functional group is EO (ethylene oxide)-modified isocyanurate diacrylate, and
the cationic polymerizable functional group is 2-ethylhexyloxetane.

3. The hard coating composition of claim 1, wherein the silsesquioxane compound includes the radical polymerizable functional group and the cationic polymerizable functional group in a ratio of about 5:5 to about 6:4.

4. The hard coating composition of claim 1, wherein the radical polymerization initiator is diphenyl(2,4,6-trimethylbenzoyl) phosphine oxide.

5. The hard coating composition of claim 1, wherein the cationic polymerization initiator is triarylsulfonium hexafluoroantimonate salts.

6. The hard coating composition of claim 1, wherein the hard coating composition includes about 80 wt % to about 91 wt % of the silsesquioxane compound, about 1 wt % to about 2 wt % of the radical polymerization initiator, and about 0.5 wt % to about 1 wt % of the cationic polymerization initiator with respect to 100% of the hard coating solid matter.

7. The hard coating composition of claim 1, wherein the hard coating solid matter further includes silica nanoparticles.

8. The hard coating composition of claim 7, wherein an average diameter of the silica nanoparticles is in a range of about 20 nm to about 60 nm.

9. The hard coating composition of claim 7, wherein the hard coating composition includes about 3 wt % to about 14 wt % of the silica nanoparticles with respect to 100 wt % of the hard coating solid matter.

10. The hard coating composition of claim 1, wherein the silsesquioxane compound has a random structure.

11. A method of manufacturing a window, the method comprising:
applying a hard coating composition including a solvent and a hard coating solid matter on a base layer to form a preliminary hard coating layer;
drying the preliminary hard coating layer to remove the solvent; and
curing the dried preliminary hard coating layer to form a hard coating layer,
wherein the hard coating solid matter includes:
a silsesquioxane compound including a radical polymerizable functional group including a (meth)acrylate group and a cationic polymerizable functional group including an oxetane group;
a radical polymerization initiator; and
a cationic polymerization initiator.

12. The method of claim 11, wherein
the radical polymerizable functional group is EO (ethylene oxide)-modified isocyanurate diacrylate, and
the cationic polymerizable functional group is 2-ethylhexyloxetane.

13. The method of claim 11, wherein the silsesquioxane compound includes the radical polymerizable functional group and the cationic polymerizable functional group in a ratio of about 5:5 to about 6:4.

14. The method of claim 11, wherein
the radical polymerization initiator is diphenyl(2,4,6-trimethylbenzoyl) phosphine oxide, and
the cationic polymerization initiator is triarylsulfonium hexafluoroantimonate salts.

15. The method of claim 11, wherein the hard coating composition includes about 80 wt % to about 91 wt % of the silsesquioxane compound, about 1 wt % to about 2 wt % of the radical polymerization initiator, and about 0.5 wt % to about 1 wt % of the cationic polymerization initiator with respect to 100 wt % of the hard coating solid matter.

16. The method of claim 11, wherein the hard coating solid matter further includes silica nanoparticles.

17. The method of claim 11, wherein the curing of the dried preliminary hard coating layer to form the hard coating layer includes:
photocuring the dried preliminary hard coating layer.

18. The method of claim 17, wherein the curing of the dried preliminary hard coating layer to form the hard coating layer further includes:
thermally curing the dried preliminary hard coating layer.

19. The method of claim 11, wherein the silsesquioxane compound has a random structure.

20. An electronic device comprising:
a window manufactured according to the method of claim 11; and
a power module that supplies power.
